(19) United States
(12) Patent Application Publication
(10) Pub. No.: US 2025/0347528 A1
(43) Pub. Date: Nov. 13, 2025

(54) METHOD FOR FINDING A CHARGING STATION FOR ELECTRIC MOTOR VEHICLES

(71) Applicants: Robert Bosch GmbH, Stuttgart-Feuerbach (DE); ASFINAG MAUTSERVICE GMBH, Salzburg (AT)

(72) Inventors: Stefan Nordbruch, Leonberg (DE); Manfred Harrer, Gumpoldskirchen (AT)

(21) Appl. No.: 18/869,590

(22) PCT Filed: May 31, 2023
(86) PCT No.: PCT/EP2023/064555

§ 371 Date: Nov. 26, 2024

(30) Foreign Application Priority Data
May 31, 2022 (DE) 10 2022 113 736.8

(51) Int. Cl. G01C 21/36; B60L 53/65; B60L 53/68; B60L 58/13; G01C 21/34; G05D 1/689; G05D 105/80; G05D 107/13; G05D 109/20; G05D 111/10; G05D 111/30

(52) U.S. Cl. CPC G01C 21/3682; B60L 53/65; B60L 53/68; B60L 58/13; G01C 21/3469; G05D 1/689; B60L 2240/60; B60L 2240/72; G05D 2105/80; G05D 2107/13; G05D 2109/20; G05D 2111/10; G05D 2111/32

(57) ABSTRACT

A method for finding a charging station for electric motor vehicles using at least one drone that has a monitoring device, includes the following steps: generating control signals for controlling the drone such that, when controlling the drone based on the generated control signals, the drone monitors an environment of an electric motor vehicle using its monitoring device and outputs monitoring data based on the monitoring; outputting the generated control signals to control the at least one drone based on the generated control signals; after outputting the generated control signals, receiving the monitoring data from the at least one drone; analysing the monitoring data to find a charging station for electric vehicles; and outputting an analysis result of the analysis of the monitoring data. The application also relates to an apparatus, a system for finding a charging station for electric motor vehicles, a computer programme, and a machine-readable storage medium.

The invention relates to a method for finding a charging station for electric motor vehicles, a system for finding a charging station for electric motor vehicles, a device, a computer program and a machine-readable storage medium.

### PRIOR ART

Electric motor vehicles have a drive battery. A charging station for electric motor vehicles can be used to charge the drive battery.

### DISCLOSURE OF THE INVENTION

The object addressed by the invention is that of providing a design for efficiently finding a charging station for electric motor vehicles.

The object is achieved by way of the subject matter of each of the independent claims. Advantageous configurations of the invention are the subject matter of the respective dependent sub-claims.

According to a first aspect, a method is provided for finding a charging station for electric motor vehicles using at least one drone that has a monitoring device, comprising the following steps:
generating control signals for controlling the at least one drone such that, when the drone is controlled based on the generated control signals, the at least one drone monitors an environment of an electric motor vehicle using its monitoring device and outputs monitoring data based on the monitoring,
outputting the generated control signals in order to control the at least one drone based on the generated control signals,
after the output of the generated control signals, receiving the monitoring data from the at least one drone,
analyzing the monitoring data to find a charging station for electric motor vehicles, and
outputting an analysis result of the analysis of the monitoring data.

According to a second aspect, a device is provided which is configured to execute all steps of the method according to the first aspect.

According to a third aspect, a system for finding a charging station for electric motor vehicles is provided, comprising:
at least one drone, wherein the at least one drone has a monitoring device, and
the device according to the second aspect.

According to a fourth aspect, a computer program is provided which comprises commands which, when the computer program is executed by a computer, for example by the device according to the second aspect and/or by the system according to the third aspect and/or by a drone comprising a monitoring device, cause said computer to execute a method according to the first aspect.

According to a fifth aspect, a machine-readable storage medium is provided, on which the computer program according to the fourth aspect is stored.

The invention is based on and incorporates the finding that the above object can be achieved by using one or more drones to find a suitable charging station at which a drive battery of the electric motor vehicle can be charged. The at least one drone, that is, the one or more drones, are controlled in such a way that they monitor an environment of the motor vehicle using their respective monitoring device and output monitoring data based on the monitoring. Thus, knowledge of the environment of the motor vehicle is made available in an advantageous and efficient manner. This knowledge is used to search for suitable charging stations for electric motor vehicles at which the drive battery can be charged.

The fact that one or more drones are used for this purpose has in particular the technical advantage that a monitoring device of a drone can also monitor areas in the environment of the motor vehicle that cannot be monitored by an environment sensor on the vehicle itself or by environment sensors on the vehicle itself. For example, an environment sensor of a motor vehicle has a certain range. The drone, on the other hand, can be controlled, for example, in such a way that it monitors a region of the environment of the motor vehicle that lies outside the range of the environment sensor of the motor vehicle. Thus, information about the environment of the motor vehicle is made available which would not be available by using environmental sensors on the vehicle itself.

Thus, in particular, this achieves the technical advantage that one or more suitable charging stations can be sought in an efficient manner so that, as a result, such charging stations can also be found efficiently in the vicinity of the motor vehicle as might not be able to be found by an environment sensor on the vehicle itself.

Thus, in an advantageous and efficient manner, a free charging station that is suitable for the electric motor vehicle can be sought.

The monitoring device of the drone can advantageously provide items of information which, for example, are not recorded in a digital map and/or which, for example, were as yet unknown to a charging station control center for managing one or more charging stations.

Thus, for example, a search time for a charging station can be advantageously shortened, which consequently saves electrical drive energy, so that, for example, a range of the electric motor vehicle is not reduced as quickly as when time and drive energy have to be used for a long search for a charging station.

In summary, a concept for efficiently finding a charging station for electric motor vehicles is provided.

If a charging station is found, it is provided, for example, that the position of the found charging station is ascertained, in particular ascertained based on the monitoring data. This means, for example, that the analysis of the monitoring data comprises, when a charging station is found, determining a position of the found charging station. The analysis result includes, for example, the ascertained position of the found charging station.

To find something, here the charging station, means in particular, from the viewpoint of the searcher, here in particular from the viewpoint of the drone or the electric vehicle, that something, here the charging station, is not known before the finding but only becomes known through the finding. For example, the term “discover” can be used instead of the term “find” and vice versa. In other words, the monitoring data is analyzed in particular to discover a charging station.

This means, for example, that before the monitoring of the environment of the electric motor vehicle, any existing charging station in the environment is in particular not known from the perspective of the drone or the electric vehicle, but is only found or discovered, for example, through the monitoring.

“To find” thus means in particular “to come across or meet by chance or while searching for someone or something, here the charging station”. “To find” thus means, in particular, “to discover someone or something”.

Thus, the wording “finding a charging station” can also be supplemented, for example, as follows: “finding an unknown charging station”. Thus, finding a charging station means in particular that a charging station is discovered by chance. “Finding” can also be replaced, for example, by “discovering by chance”.

Whenever the drone is used in the singular in the description, the plural is deemed to be always implied, and vice versa. Statements made in connection with a drone apply analogously to multiple drones, and vice versa.

The phrase “at least one” means “one or more”. This means in particular that, for example, multiple drones can be used. For example, multiple drones are all identical or all different.

For example, the monitoring devices of at least some, in particular all, of the drones are identical or, for example, at least some, in particular all of them, are different.

A monitoring device for the purposes of the description comprises, for example, one or more environment sensors. This means in particular that the drone has one or more environment sensors, for example. The drone is therefore equipped in particular with one or more environment sensors.

An environment sensor of a monitoring device, for example, captures an environment of the motor vehicle and outputs environment sensor data based on the results. Such environment sensor data is included, for example, in the monitoring data.

This means in particular that, for the purposes of the description, monitoring comprises capturing an environment of the motor vehicle using an environment sensor of the monitoring device.

Whenever the environment sensor is used in the singular, the plural is deemed to be always implied, and vice versa. Statements made in connection with an environment sensor apply analogously to multiple environment sensors, and vice versa.

For example, an environment sensor as described in the description is one of the following environment sensors: LiDAR sensors, a radar sensor, an image sensor, in particular an image sensor of a video camera or a stereo camera, an ultrasound sensor, an infrared sensor and a magnetic field sensor.

For example, environment sensors can be identical or they can be different.

In one embodiment of the method, this comprises a step of controlling the at least one drone based on the output control signals.

In one embodiment of the method, this comprises a step of monitoring the environment of the motor vehicle using the at least one drone.

In one embodiment of the method, this comprises a step of capturing the environment of the motor vehicle using an environment sensor of the monitoring device.

In one embodiment of the method, this comprises a step of wireless transmission of the output control signals to the at least one drone. Such wireless transmission includes, for example, sending control signals over a wireless communication network, such as a cellular radio network and/or WLAN network.

Receiving the monitoring data comprises, for example, wireless reception of the monitoring data, in particular wireless reception of the monitoring data via a wireless communication network, for example a cellular radio network and/or a WLAN network.

In one embodiment of the method, this is a computer-implemented method.

The embodiments and exemplary embodiments described in the description can be combined with each other in any form, even if this is not explicitly described.

For example, the analysis result indicates whether or not a charging station for electric motor vehicles has been found. If a charging station is found, the analysis result indicates, for example, the position of the charging station found.

For example, multiple charging stations may be found. Statements made in connection with one charging station apply analogously to multiple charging stations, and vice versa.

A charging station for the purposes of the description is a charging station for electric motor vehicles.

An electric motor vehicle for the purposes of the description has a drive battery and an electric motor, which can be supplied with electrical energy by the drive battery.

Analyzing the monitoring data, for example, involves processing the monitoring data. The monitoring data is processed, for example, using one processor or using multiple processors. This means, for example, that the analysis can be performed using one computer or a plurality of computers.

In one embodiment of the method, it is provided that dimensional signals are received which represent one or more dimensions of the electric motor vehicle, wherein the monitoring data is analyzed based on the dimensional signals, the analysis comprising testing a found charging station to determine whether a drive battery of the electric vehicle can be charged in the found charging station based on its dimension or dimensions.

This achieves the technical advantage, for example, that a found charging station can be efficiently tested for its suitability, namely whether the motor vehicle can even be parked on the found charging station due to its size, that is, due to its dimensions, in order to charge a drive battery of the electric motor vehicle.

For example, a dimension is one of the following dimensions: length, width, height.

In one embodiment of the method it is provided that the analysis comprises testing a found charging station to determine whether said charging station is accessible for the electric motor vehicle.

This, for example, achieves the technical advantage that it can be efficiently ensured that a found charging station can be accessed by the motor vehicle at all, i.e. whether the motor vehicle can drive up to the found charging station at all.

Testing whether a found charging station is accessible for the motor vehicle at all comprises, for example, checking whether an entrance to the charging station, in particular an entrance into a defined area within which the found charging station is located, is wide enough that the motor vehicle can drive through the entrance, and/or checking whether there are one or more objects, for example a construction site marker or a pillar, for example a construction site pillar, in front of the charging station, which hinder or could prevent entry into the charging station, and/or checking whether a necessary drive-in radius for entering the charging station is feasible for the motor vehicle based on a maximum possible steering angle of the motor vehicle.

In one embodiment of the method it is provided that the analysis comprises ascertaining an occupancy state of a found charging station.

For example, this results in the technical advantage that the occupancy state can be efficiently ascertained. For example, an occupancy state is free or occupied or partially free or partially occupied. For example, it may already be known that there is a charging station in the vicinity of the motor vehicle. However, it may not be known whether this is (partially) occupied or (partially) free, for example. Using the drone, it is thus possible and in particular provision is made to ascertain a current occupancy state even before the electric motor vehicle itself arrives at the charging station.

In one embodiment of the method it is provided that the analysis comprises, if a charging station is found which is located within a defined area, ascertaining a position of the found charging station with respect to the area.

This has the technical advantage, for example, that the found charging station can be found efficiently within the area.

For example, an area is an element selected from the following group of areas: a parking lot, a parking lot of a supermarket, a rest area, a roadside verge.

Within the examples of areas mentioned above, for example, one or more charging stations may be arranged. The position of the found charging station in relation to the area thus indicates where the found charging station is located within the area; for example, where the found charging station is located relative to a reference point or fixed point of the area. Such a reference point or fixed point is, for example, an entrance or an exit. For example, it can thus be ascertained where a charging station of a parking lot is located in relation to the entrance or exit.

In one embodiment of the method, it is provided that, in the case of an analysis result which indicates that a charging station for the motor vehicle has been found, additional control signals for controlling the at least one drone are generated in such a way that, during further control of the drone based on the generated additional control signals, the at least one drone monitors the found charging station using its monitoring device and outputs additional monitoring data based on the monitoring, wherein the generated additional control signals are output to further control the at least one drone based on the generated additional control signals, wherein after the output of the additional control signals the additional monitoring data is received and the additional monitoring data is analyzed to determine an additional analysis result, which is output.

This has the technical advantage, for example, that the found charging station is monitored further, so that further up-to-date knowledge about the found charging station is available. Analyzing the additional monitoring data includes, for example, ascertaining whether or not a current occupancy state of the charging station changes. For example, before the electric vehicle arrives at the charging station, it can be detected that an initially free charging station has been occupied by another electric vehicle in the meantime, so that, for example, a new charging station must be sought using the drone. This effectively prevents the electric motor vehicle from driving to the charging station to no avail.

Statements that are made in connection with the control, the monitoring and the analysis apply analogously to the further control, further monitoring and further analysis, and vice versa.

In one embodiment of the method, it is provided that charging station route signals are generated, which represent a charging station route from a starting position to a found charging station for the electric motor vehicle, wherein the generated charging station route signals are output.

This has the technical advantage, for example, that the electric motor vehicle can be efficiently directed to the found charging station. In particular, the ascertained charging station route based on which the electric motor vehicle can drive to the found charging station is thus specified to the electric motor vehicle.

The starting position is, for example, the current position of the electric motor vehicle or is, for example, a future position of the electric motor vehicle. The future position of the electric motor vehicle can be predicted, for example.

In one embodiment of the method the analysis comprises, if a plurality of charging stations are found, ascertaining the optimal charging station.

This results in the technical advantage, for example, that it efficiently ensures that an optimal charging station for the electric vehicle is found with regard to charging the drive battery of the electric vehicle.

An optimal charging station is, for example, the charging station closest to the electric motor vehicle and to a direction of travel of the electric motor vehicle. An optimal charging station is, for example, that charging station of the found charging stations which offers the most space for charging the drive battery of the electric motor vehicle. An optimal charging station is, for example, that charging station of the found charging stations which can be best accessed for charging the drive battery of the electric motor vehicle. For example, ‘best’ can mean that there are no objects that hinder or prevent driving up to the charging station. For example, best can additionally or alternatively mean that the required drive-in radius is a minimum relative to the required drive-in radii of the other charging stations.

In one embodiment of the method, it is provided that route signals are received which represent a current route of the electric motor vehicle based on which the electric motor vehicle is currently driving, wherein the control signals are generated based on the route signals and/or wherein the monitoring data is analyzed based on the route signals.

This results in the technical advantage, for example, that the control signals can be generated efficiently and/or that the monitoring data can be analyzed efficiently.

According to this embodiment, knowledge of where the electric vehicle is heading is therefore available. Accordingly, it is possible to specify to the drone by way of the control signals which region in the environment of the electric motor vehicle the drone should monitor using its monitoring device, so that the drone will subsequently also monitor this region according to the control signals using its monitoring device. For example, by way of the control signals, a region is specified to the drone in the vicinity of the electric vehicle to be monitored, which lies in front of the electric vehicle in the direction of travel according to the current route of the electric motor vehicle.

If it is known where the electric vehicle is heading, the region which is in front of the electric vehicle in the direction of travel of the current route can accordingly be analyzed for possible charging stations, so that accordingly the monitoring data can be analyzed efficiently.

In one embodiment of the method, it is provided that environment signals are received which represent the environment of the electric motor vehicle, wherein the control signals are generated based on the environment signals and/or wherein the monitoring data is analyzed based on the environment signals.

This results in the technical advantage, for example, that the control signals can be generated efficiently and/or that the monitoring data can be analyzed efficiently.

According to this embodiment, additional knowledge about the environment of the electric motor vehicle is thus available, which can be used in combination with the monitoring data to seek suitable charging stations and find them accordingly. If additional knowledge about the electric motor vehicle environment is available, the drone can be advantageously controlled in an efficient way so that it does not collide, for example, with infrastructure objects. An infrastructure object is, for example, a building, or a traffic signal light installation, a mast, or, for example, a traffic sign. Objects with which the drone could collide include, for example, vegetation such as trees and/or shrubs. Knowledge about such vegetation can also be represented by the environment signals, for example.

In one embodiment of the method, it is provided that the environment signals comprise environment signals transmitted from an additional motor vehicle, which is located in front of the electric motor vehicle with respect to a direction of travel of the electric motor vehicle.

This results in the technical advantage, for example, that particularly suitable environment signals can be used for generating the control signals and/or for analyzing the monitoring data. The additional knowledge about the environment of the electric vehicle is thus made available according to this embodiment by an additional motor vehicle (“additional motor vehicle”, because the electric motor vehicle is also a motor vehicle), which captures its own environment using its own vehicle environment sensor or its own vehicle environment sensors, wherein of course this own environment is included in the environment of the electric vehicle, so that appropriate knowledge about the environment of the motor vehicle which is in the direction of travel can be made available in an efficient manner.

In one embodiment of the method, it is provided that the environment signals comprise map signals which represent a digital map of the environment of the electric motor vehicle, indicating a respective position of one or more charging stations.

This results in the technical advantage, for example, that particularly suitable environment signals can be used for generating the control signals and/or for analyzing the monitoring data. According to this embodiment, a digital map of the environment of the electric motor vehicle is thus provided.

Environment signals can include, for example, environment signals sent from a cloud infrastructure. In the cloud infrastructure, for example, a charging station control center is implemented and/or, for example, cloud data on charging stations is stored.

In one embodiment of the method, it is provided that the environment signals comprise environment signals transmitted from a traffic control center and/or from a charging station control center.

This results in the technical advantage, for example, that particularly suitable environment signals can be used for generating the control signals and/or for analyzing the monitoring data. The additional knowledge about the environment of the electric vehicle is thus provided according to this embodiment by a traffic control center, which should be deemed to always imply the charging station control center. This usually has up-to-date knowledge about the environment of the electric motor vehicle, which, for example, has not yet been incorporated into a digital map of the environment. For example, the traffic control center will know the position of a newly established charging station which is not yet listed in the digital map. For example, the traffic control center knows that a charging station which is listed in a digital map currently no longer exists or has changed its position. This knowledge is represented by the environment signals.

In one embodiment of the method, it is provided that one, more than one or all of the method steps are carried out by the electric motor vehicle and/or by the infrastructure and/or by the drone.

For example, this results in the technical advantage that the individual method steps can be carried out efficiently.

In one embodiment of the method it is provided that the method is started only when a current charge state of a drive battery of the electric motor vehicle is less than or equal to a predetermined charge state threshold value, or wherein the method is started proactively independently of the current charge state of the drive battery of the electric motor vehicle.

For example, this results in the technical advantage that the method can be carried out efficiently.

The proactive embodiment has the advantage, for example, that a charging station can be sought and found regardless of the current or instantaneous charge state. Thus, for example, it can be ascertained that there is currently, i.e. now, a suitable charging station which is free, i.e. unoccupied, whereas charging stations that come after the suitable charging station in relation to the route of the motor vehicle will probably no longer be free. Probably means, for example, with a probability that is greater than or equal to a predetermined probability threshold. The proactive embodiment is particularly advantageous if the drive battery needs to be charged at least once before the destination of the route is reached.

If the method is started only when the instantaneous charge state is less than or equal to the predetermined charge state threshold, the resources required for the method, in particular computing resources, can be advantageously used in an efficient manner. For example, an energy storage device of the drone can be used efficiently. This is because, for example, the drone is only started when the current charge state is less than or equal to the predetermined charge state threshold.

In one embodiment of the method it is provided that, based on the analysis result, infrastructure assistance data is ascertained for the infrastructure-supported assistance of the electric motor vehicle (505) during an at least partially automatically guided journey to a found charging station and sent to the electric motor vehicle (505).

Infrastructure assistance data includes, for example, a recommendation for action for the electric vehicle and/or includes, for example, remote-control commands for remote control of a transverse and/or longitudinal guidance of the electric vehicle. For example, infrastructure assistance data includes the analysis result. For example, infrastructure assistance data includes the determined charging station route from the starting position to the found charging station.

In one embodiment of the method it is provided that, based on the analysis result, electric motor vehicle control signals for the at least partially automated control of a transverse and/or longitudinal guidance of the electric motor vehicle are generated and output.

This results in the technical advantage that, for example, the electric motor vehicle control signals can be efficiently generated.

In one embodiment of the method, this comprises a step of controlling a transverse and/or longitudinal guidance of the electric motor vehicle based on the output electric motor vehicle control signals.

In one embodiment of the method, the monitoring data and/or the analysis result are sent to a traffic control center and/or a charging station control center.

This achieves the technical advantage, for example, that the traffic control center, which is deemed to always imply the charging station control center, is efficiently put in a position to plan one or more actions based on the analysis result and/or based on the monitoring data and, for example, to control and/or coordinate them accordingly.

In one embodiment of the method, it is provided that the control signals, in particular the additional control signals, are generated in such a way that, when the at least one drone is controlled based on the generated control signals, the monitoring of the environment comprises a live monitoring of the environment of the electric motor vehicle so that the monitoring data, in particular the additional monitoring data, comprises live monitoring data.

This achieves the technical advantage, for example, of efficiently monitoring the environment of the electric motor vehicle so that suitable charging stations can be found in an efficient manner.

For example, the live monitoring comprises live monitoring of one or more charging stations and/or live monitoring of a particular charging station environment of one or more charging stations. The (additional) control signals are thus, for example, of such a kind that the at least one drone monitors a found charging station and/or its surroundings using the drone's monitoring device. (Additional) live monitoring data therefore represents, for example, a found charging station and/or its surroundings.

Device features and/or system features arise analogously from corresponding method features and vice versa. Statements made in connection with the method and/or the means and/or the system shall apply analogously to statements made in connection with the system and/or the means and/or the method, and vice versa.

In one embodiment of the method it is provided that the at least one drone is assigned to the electric motor vehicle. This means, for example, that the at least one drone belongs to the electric motor vehicle and is used or deployed by the electric motor vehicle. This means, for example, that the at least one drone is controlled by the electric vehicle. This means in particular that the control signals are generated and output by the electric motor vehicle itself. The electric motor vehicle sends the generated and output control signals wirelessly, for example, to the at least one drone to control it. For example, the at least one drone accompanies the electric motor vehicle and, for example, flies ahead of the electric vehicle in relation to the direction of travel of the electric vehicle. For example, the electric motor vehicle starts the at least one drone if the current charge state of the drive battery is less than or equal to the predetermined charge state threshold value.

In one embodiment of the method it is provided that the at least one drone is assigned to an infrastructure. This means, for example, that the at least one drone belongs to the infrastructure. The at least one drone is assigned, for example, to a charging area comprising one or more charging stations, that is, for example, to a road with one or more charging stations or a parking lot with one or more charging stations. This means, for example, that the at least one drone waits at a charging area until it is deployed and is then activated accordingly. The at least one drone can, for example, fly continuously and can also be used for other tasks if it is not currently to be used for the method for finding a charging station according to the first aspect. The control of the at least one drone can be carried out, for example, on the infrastructure side, i.e. by the infrastructure. This means that the control signals are generated and output by the infrastructure. The infrastructure sends the output control signals, for example, wirelessly to the at least one drone. Within the infrastructure, a charging park management and/or drone system can be provided, which performs this control.

In the embodiment according to which the drone is assigned to the infrastructure, the control can alternatively or additionally also be performed by the electric motor vehicle.

The control signals are generated, for example, using a digital map of the environment of the electric motor vehicle. The control signals can be generated, for example, based on a current route of the electric motor vehicle. For example, the control signals for the at least one drone can be generated based on possible routes of the electric motor vehicle. This means that the control signals can be generated, for example, based on possible routes of the electric vehicle.

In one embodiment of the method, it is provided that the control signals are generated in such a way that the at least one drone flies over all possible routes of the electric motor vehicle, in front of the electric vehicle relative to the direction of travel of the electric motor vehicle, and monitors them accordingly using its monitoring device. This means that, according to this embodiment, it is provided that the at least one drone searches for all possible charging stations in the environment of the electric motor vehicle which is located in front of the electric motor vehicle in relation to its direction of travel, but without knowing the specific route or a specific destination of the electric motor vehicle.

In one embodiment of the method, the at least one drone is provided with known data on road sections, more generally on the environment of the electric motor vehicle, or such data is sent to them. Such known data includes, for example, data on a road width, a position of charging stations, position of signs. Typically, this data includes data about stationary objects, i.e. where is a charging station, for example.

According to one embodiment, the data comprises dynamic data, i.e. information on whether such a charging station is occupied or free, for example. The monitoring device can be used to check whether the charging station is actually occupied or not. In general, this known data can be validated by the at least one drone by analyzing and evaluating the monitoring data accordingly.

In one embodiment of the method it is provided that data from one or more additional motor vehicles, which are located in particular ahead of the electric motor vehicle in relation to the direction of travel of the electric vehicle, is also used. This data is represented, for example, by the environment signals described here, which are transmitted by an additional motor vehicle.

In one embodiment of the method, it is provided that the drones are used for the validation of known data, i.e., for example, the digital map and/or the environment signals, which represent an environment of the electric motor vehicle, wherein said environment signals are sent, for example, from an additional motor vehicle which is located ahead of the electric vehicle in relation to the direction of travel of the electric motor vehicle.

In one embodiment of the method it is provided that the at least one drone is completely controlled by the electric vehicle and/or by the infrastructure.

In one embodiment of the method it is provided that the at least one drone is a smart drone. This means that the at least one drone can autonomously monitor the environment of the electric motor vehicle or the surroundings of the electric motor vehicle. The at least one drone controls itself and acts on its own.

In one embodiment of the method, it is provided that the at least one drone continues to learn with each use, in particular using machine learning methods.

For example, a machine learning method checks whether a planned objective was able to be achieved during an earlier execution of the method. An objective, for example, is that the found charging station was accessible and/or had sufficient space available, i.e. sufficiently large dimensions.

For example, a machine learning method tests whether the dimensions of the electric vehicle matched the ascertained dimensions of the charging station in an earlier execution of the method, i.e. whether a drive battery of the electric motor vehicle could be charged at the found charging station at that time or whether the electric motor vehicle would have needed a larger charging station at that time.

For example, a machine learning method tests whether a planned target trajectory for driving up to the charging station could be driven at least partially automatically by the electric motor vehicle. If not, for example, an algorithm for determining such a target trajectory can be adapted.

For example, a machine learning method simulates the execution of the method.

A machine learning method uses, for example, data from one or more additional motor vehicles and/or drones to determine, for example, one or more optimal control parameters for the drone control so that the control signals for the drone are generated based on the one or more optimal control parameters.

A result or results of a machine learning method are used in a current execution of the method, for example.

The method comprises, according to one embodiment, carrying out a machine learning method.

In one embodiment of the method it is provided that any combination from a dumb to a smart drone is possible. This means that the at least one drone can still be a smart drone, but it is additionally monitored by the electric motor vehicle and/or the infrastructure.

Communication between the drone and the electric motor vehicle is, for example, a direct communication. This means that data and/or signals can be exchanged directly between the at least one drone and the electric motor vehicle.

In one embodiment of the method, it is provided that communication between the drone and the electric motor vehicle is an indirect communication. This means that data and/or signals are transmitted between the at least one drone and the electric motor vehicle via an external system, such as a cloud and/or backend system or a local charging park system and/or a road management system and/or a drone system.

A backend system comprises, for example, a server system, which is located in an operational control center, for example. In particular, this means that in the case of a backend, for example, a location of the server system is known. A cloud system comprises, for example, a server system, the location of which is unknown, for example.

The cloud is also a server system where the location may not be known.

In one embodiment of the method it is provided that communication between drones and electric motor vehicle and infrastructure is a secure connection. This means, for example, that the communication can be secured, in particular encrypted, using certificates.

The at least one drone has, for example, a monitoring device, which comprises one or more environment sensors. These environment sensors are, for example, environment sensors according to different sensor technologies. For example, these environment sensors are radar sensors, image sensors and/or LiDAR sensors. Thus, in addition to images, other information can be determined, such as distances, dimensions, or information about objects. In particular, this increases security if multiple environmental sensors are used in the sense of redundancy and different ones in the sense of diversity.

In one embodiment of the method, it is provided that the (additional) monitoring data and/or the (additional) analysis result and/or, for example, infrastructure assistance data are sent to a traffic control center and/or road control center. Such control centers can then plan additional actions, for example. Such additional actions include, for example, traffic diversions and/or updating of occupancy data at the charging station and/or reserving a charging station and/or controlling and/or initiating and/or coordinating the vacating of an occupied charging station.

When one of the terms road traffic control center, road control center and traffic management center is used, the other terms should always be deemed to be implied. These are used synonymously.

In particular, a charging station control center manages one or more charging stations. The charging station control center is in particular set up to manage one or more charging stations.

In one embodiment of the method, it is provided that the environment of the electric motor vehicle is monitored live using the monitoring device of the at least one drone.

In one embodiment of the method it is provided that one, more than one or all the method steps are documented, in particular in a blockchain.

For example, the system according to the third aspect is configured to execute all the steps of the method according to the first aspect.

In one embodiment of the method according to the first aspect, it is provided that the method is carried out using the system according to the third aspect.

A drone for the purposes of the description is an unmanned aircraft.

A drone is, for example, a quadcopter, a helicopter, an octocopter, a hexacopter, in general a multicopter.

In one embodiment, it is provided that the method and/or the device and/or the system and/or the storage medium and/or the electric motor vehicle and/or the drone are secure.

The German term “sicher” in the context of the description means in particular “safe” and “secure” for the purposes of the description. Although these two English terms are usually translated into German as “sicher”, in English they have somewhat different meanings.

The term “safe” is directed in particular at the subject of accidents and accident prevention. “Safe” therefore means in particular that measures are taken to ensure the correct function of the means and/or the system and/or the storage medium and/or the execution of the method steps.

The term “secure” is directed in particular at the subject of computer security and protection against hackers, in particular: how securely are the means and/or the storage medium and/or the system and its components protected from unauthorized access and data manipulation by third parties, so-called “hackers”? A method and/or the storage medium and/or a means and/or a system which are “secure” thus, in particular, rely on adequate and sufficient computer security and protection from hackers as a basis for carrying out the method steps and for the functionality of the means and/or the system.

For example, safe means that one or more safety conditions are met.

For example, it is provided that one, more than one or all the components, for example the electric motor vehicle and/or the drone, which are involved in carrying out the method and/or which are comprised by the means and/or by the system, and/or the storage medium are safe, that is, for example, one or more safety conditions are met.

In particular, this achieves the technical advantage that the system and/or the method and/or the means and/or the storage medium are safe as defined in the description, that is, in particular, both “safe” and “secure”.

In one embodiment, it is provided that the one or more safety conditions are each an element selected from the following group of safety conditions: the existence of a predetermined minimum ASIL and/or minimum SIL in at least one of the components, the existence of redundancy in at least one of the components, the existence of diversity in at least one of the components, the existence of at least one plan which includes measures to reduce errors and/or measures in the event of failures of at least one of the components and/or which includes measures for error analysis and/or measures in the event of misinterpretations, the existence of one or more fallback scenarios.

This, for example, achieves the technical advantage of providing particularly suitable safety conditions.

The abbreviation “ASIL” stands for the term “Automotive Safety Integrity Level”. “Automotive Safety Integrity Level” is a key component of the ISO 26262 standard. ASIL distinguishes between four different ASIL risk levels, which are denoted by ASIL-A, ASIL-B, ASIL-C, and ASIL-D.

The abbreviation “SIL” stands for the term “Safety Integrity Level”. “Safety Integrity Level” is a key component of the IEC EN 61508 standard. SIL distinguishes between four different SIL risk levels, which are denoted by SIL-1, SIL-2, SIL-3 and SIL-4.

In one embodiment of the method it is provided that one, more than one or all steps of the method are carried out only if one or more safety conditions, in particular one or more of the above safety conditions, are met.

For example, the method is carried out only if the one or more safety conditions are met.

In one embodiment of the method, it is provided that the electric motor vehicle is an at least partially automatically guided electric motor vehicle.

The phrase “at least partially automatically guided” includes one or more of the following cases: assisted guidance, partially automated guidance, highly automated guidance, fully automated guidance. The phrase “at least partially automated” thus covers one or more of the following terms: assisted, partially automated, highly automated, fully automated.

Assisted guidance means that a driver of the electric motor vehicle always performs either the transverse or longitudinal guidance of the electric motor vehicle. The respective other driving task (i.e. controlling the longitudinal or transverse guidance of the electric motor vehicle) is carried out automatically. This means that in the case of assisted guidance of the electric motor vehicle, either the transverse or the longitudinal guidance is automatically controlled.

Partially automated guidance means that in a specific situation (for example: driving on a highway, driving within a parking lot, overtaking an object, driving within a lane defined by lane markings) and/or for a certain period of time the longitudinal and transverse guidance of the electric motor vehicle are automatically controlled. A driver of the electric motor vehicle does not him/herself have to manually control the longitudinal and transverse guidance of the electric motor vehicle. However, the driver must continuously monitor the automatic control of the longitudinal and transverse guidance in order to be able to intervene manually if necessary. The driver must be ready at all times to take full control of the vehicle guidance.

Highly automated guidance means that for a certain period of time in a specific situation (for example: driving on a highway, driving within a parking lot, overtaking an object, driving within a lane defined by lane markings) the longitudinal and transverse guidance of the electric motor vehicle are automatically controlled. A driver of the electric motor vehicle does not him/herself have to manually control the longitudinal and transverse guidance of the electric motor vehicle. However, the driver does not need to continuously monitor the automatic control of the longitudinal and transverse guidance in order to be able to intervene manually if necessary. If necessary, a control transfer request is automatically issued to the driver to assume control of the longitudinal and transverse guidance, in particular with a sufficient time reserve. This means that the driver must potentially be in a position to assume control of the longitudinal and transverse guidance. Limits of the automatic control of the transverse and longitudinal guidance are automatically detected. With highly automated guidance, it is not possible to automatically bring about a minimal-risk state in every initial situation.

Fully automated guidance means that in a specific situation (for example: driving on a highway, driving within a parking lot, overtaking an object, driving within a lane defined by lane markings) the longitudinal and transverse guidance of the electric motor vehicle are automatically controlled. A driver of the electric motor vehicle does not him/herself have to manually control the longitudinal and transverse guidance of the electric motor vehicle. However, the driver does not need to monitor the automatic control of the longitudinal and transverse guidance in order to be able to intervene manually if necessary. Before the automatic control of the lateral and longitudinal guidance is ended, the driver is automatically prompted to assume the driving task (control of the transverse and longitudinal guidance of the electric motor vehicle), in particular with a sufficient time reserve. If the driver does not assume the driving task, the vehicle is automatically returned to a minimal-risk state. Limits of the automatic control of the transverse and longitudinal guidance are automatically detected. In all situations, it is possible to return automatically to a minimal-risk system state.

A drive battery, which can also be referred to as a high-voltage accumulator, traction battery or cycling battery, is in particular an accumulator which is primarily intended to supply electrical energy to the electric motor providing propulsion for the electric motor vehicle.

The invention will be discussed in more detail below on the basis of preferred exemplary embodiments. In the drawings:

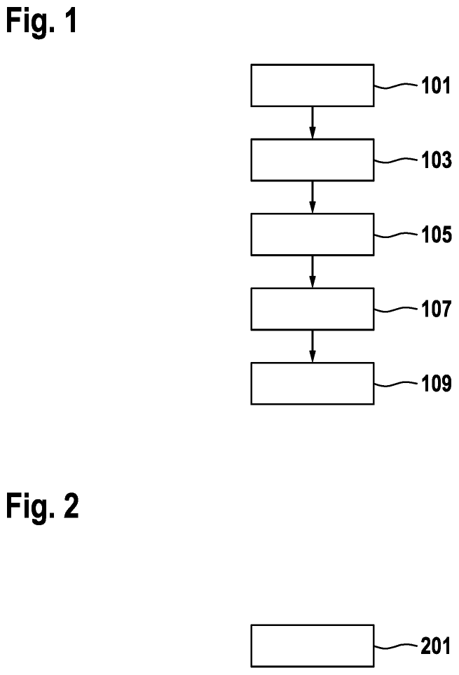

FIG. 1 shows a flowchart of a method according to the first aspect,

FIG. 2 shows a device according to the second aspect,

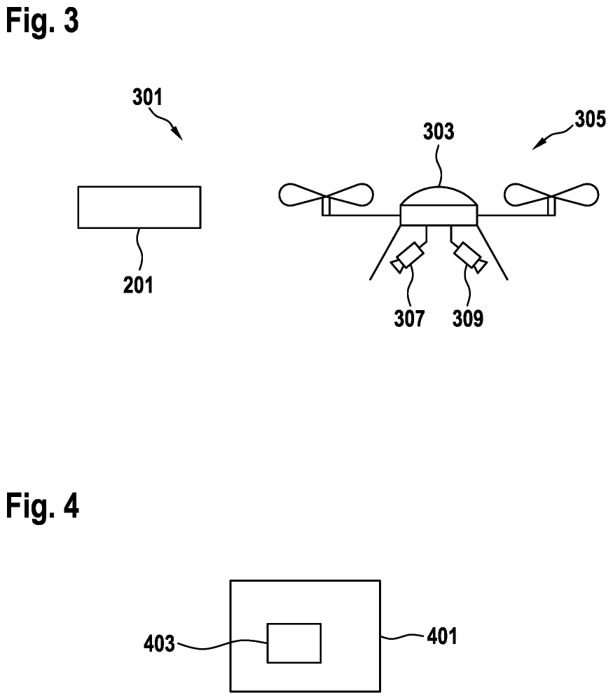

FIG. 3 shows a system according to the third aspect,

FIG. 4 shows a machine-readable storage medium according to the fifth aspect, and

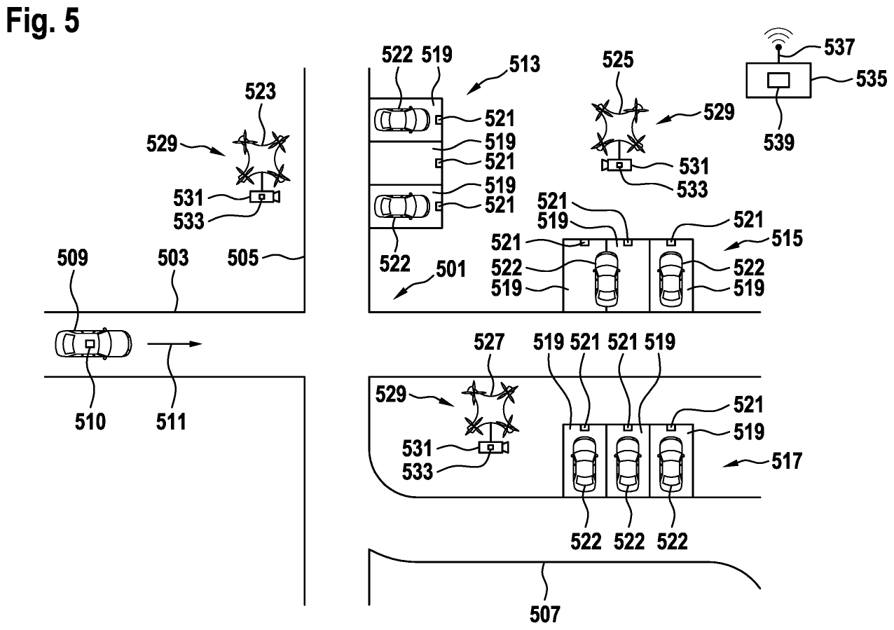

FIG. 5 shows an exemplary application of the method according to the first aspect.

In the following, the same reference signs can be used for the same features.

FIG. 1 shows a flowchart of a method for finding a charging station for electric motor vehicles using at least one drone that has a monitoring device, comprising the following steps:
generating 101 control signals for controlling the at least one drone such that, when the drone is controlled based on the generated control signals, the at least one drone monitors an environment of an electric motor vehicle using its monitoring device and outputs monitoring data based on the monitoring,
outputting 103 the generated control signals in order to control the at least one drone based on the generated control signals,
after the output of the generated control signals, receiving 105 the monitoring data from the at least one drone,
analyzing 107 the monitoring data in order to find a charging station for electric motor vehicles, and
outputting 109 an analysis result of the analysis of the monitoring data.

FIG. 2 shows a device 201. The device 201 is configured to execute all steps of the method according to the first aspect.

The device 201 comprises, according to an embodiment not shown, an input which is designed to receive the signals and/or data described in the description. The device 201, according to an embodiment not shown, comprises one or more processors which are designed to execute the steps of (further) analysis and/or processing and/or ascertaining as described in the description. The device 201, according to an embodiment not shown, comprises an output which is designed to output the signals and/or data described in the description. For example, the device 201 comprises the input, the processor(s), and the output. For example, the input comprises a wireless communication interface. For example, the output comprises a wireless communication interface. For example, the input and output are identical. For example, the device 201 comprises a wireless communication interface for bi-directional communication, that is, for receiving and transmitting the signals and/or data described in the description.

The device 201 can be implemented, for example, in a drone which is used for the method according to the first aspect.

FIG. 3 shows a system 301 for finding a charging station for electric motor vehicles.

The system 301 comprises the device 201 according to FIG. 2.

The system 301 comprises a drone 303. The drone 303 comprises a monitoring device 305. The monitoring device 305 comprises a first video camera 307 and a second video camera 309, each of which comprises an image sensor, not shown, as an environment sensor.

In an embodiment not shown, the monitoring device 305 comprises further environment sensors in addition or as an alternative to one or both of the video cameras 307, 309.

In an embodiment not shown, the system 301 comprises a plurality of drones, which are designed, for example, identically or, for example, differently.

FIG. 4 shows a machine-readable storage medium 401 on which a computer program 403 is stored. The computer program 403 comprises commands which, when the computer program 403 is executed by a computer, cause said computer to execute a method according to the first aspect.

FIG. 5 shows an intersection 501, where a first road 503 and a second road 505 cross each other. The first road 503 runs horizontally in relation to the plane of the paper. The second road 505 runs perpendicular to the plane of the paper. Below the intersection 501, a third road 507 leads away from the second road 505 as a side road.

An electric motor vehicle 509 comprising a drive battery 510 for an electric motor (not shown) of the electric motor vehicle 509 is driving on the first road 503 in the direction of travel 511 towards intersection 501. The direction of travel 511 of the electric motor vehicle 509 runs from left to right in relation to the plane of the paper.

A first charging area 513 and a second charging area 515 and a third charging area 517 are provided. The first charging area 513 is located above the intersection 501 to the right of the second road 505. The second charging area 515 is located above the intersection 501 and to the right of intersection 501 on the first road 503. The third charging area 517 is located below the intersection 501 on the third road 507.

The three charging areas 513, 515, 517 each comprise three parking spaces 519 on which motor vehicles, in particular electric motor vehicles, can be parked. Each of the parking spaces 519 has its own charging station 521 for electric motor vehicles, at which a drive battery of an electric motor vehicle can be charged.
Further motor vehicles 522 are parked on some of the parking spaces 519.
In particular, for the first charging area 513, a further motor vehicle 522 is parked on the upper parking space 519 and a further motor vehicle 522 is parked on the lower parking space 519. The middle parking space 519 is empty.

For the second charging area 515, a further motor vehicle 522 is parked on the left-hand and on the middle parking spaces 519 in such a way that this additional motor vehicle 522 blocks both parking spaces 519. Furthermore, a further motor vehicle 522 is parked in the right-hand parking space 519 of the second charging area 515.

For the third charging area 517, a further motor vehicle 522 is parked on each of the parking spaces 519.

A first drone 523 and a second drone 525 and a third drone 527 are provided. The three drones 523, 525, 527 each comprise a monitoring device 529, each of which has a video camera 531 and an image sensor 533.

Furthermore, a device 535 is provided which is configured to execute all steps of the method according to the first aspect. The device 535 comprises a wireless communication interface 537 and comprises a processor device 539, which may have, for example, one or more processors.

According to the concept described here, it is provided that the three drones 523, 525, 527 are used to search, for example, for vacant parking spaces 519 of the charging areas 513, 515, 517 using their monitoring device 529. For example, the drones 523, 525, 527 can be used to ascertain and/or validate the occupancy status of the parking spaces 519.

For this purpose, it is provided that, for example, the drones 523, 525, 527 are controlled using the device 535. For example, the processor device 539 generates the control signals. Using the wireless communication interface 537, which can comprise, for example, a WLAN communication interface and/or a cellular radio interface, the control signals are sent to the drones 523, 525, 527 wirelessly.

The drones 523, 525, 527 fly over the charging areas 513, 515, 517, for example, and can monitor the charging areas 513, 515, 517 using their respective monitoring device 520. In particular, the video cameras 531 record video images of the charging areas 513, 515, 517, which can be sent, for example, to the device 535. These video images are, for example, monitoring data as defined in the description, or comprised by such data. These video images are sent wirelessly to the device 535, which receives them via the wireless communication interface 537.

The processor device 539 analyzes the video images in order, for example, to determine and/or validate a respective occupancy status of the parking spaces 519.

Thus, for example, an analysis result is available which indicates the respective occupancy status of the parking spaces 519. This analysis result can be output using the wireless communication interface 537, in particular it can be sent to the electric motor vehicle 509. The electric motor vehicle 509 can be, for example, an at least partially automatically guided electric motor vehicle, which can plan, for example, an at least partially automated journey based on the analysis result. For example, the electric motor vehicle 509 can select, from the three charging areas 513, 515, 517, the first charging area 513 as the charging area to which the electric motor vehicle 509 will drive at least partially automatically, provided this charging area still has a free parking space 519, and the drive battery 510 of the electric motor vehicle 509 can be charged at its charging station 521.

In an embodiment not shown, it may be provided that at least one of the drones 523, 525, 527 or all the drones 523, 525, 527 is or are controlled using the electric motor vehicle 509.

In an embodiment not shown, for example, it is provided that instead of the drones 523, 525, 527 more or fewer drones are provided, for example only one drone.

1. A method for finding a charging station for electric motor vehicles using at least one drone that has a monitoring device, comprising the following steps:
generating control signals for controlling the at least one drone such that, when the drone is controlled based on the generated control signals, the at least one drone monitors an environment of an electric motor vehicle using its monitoring device and outputs monitoring data based on the monitoring,
outputting the generated control signals in order to control the at least one drone based on the generated control signals,
after the output of the generated control signals, receiving the monitoring data from the at least one drone,
analyzing the monitoring data to find a charging station for electric motor vehicles, and
outputting an analysis result of the analysis of the monitoring data.

2. The method as claimed in claim 1, wherein dimensional signals are received which represent one or more dimensions of the electric motor vehicle, wherein the monitoring data is analyzed based on the dimensional signals, the analysis comprising testing a found charging station to determine whether a drive battery of the electric vehicle can be charged in the found charging station based on its dimension or dimensions.

3. The method as claimed in claim 1, wherein the analysis comprises testing a found charging station to determine whether said charging station is accessible for the electric motor vehicle.

4. The method as claimed in claim 1, wherein the analysis comprises ascertaining an occupancy status of a found charging station.

5. The method as claimed in claim 1, wherein the analysis comprises, if a charging station is found which is located within a defined area, ascertaining a position of the found charging station with respect to the area.

6. The method as claimed in claim 1, wherein, in the case of an analysis result which indicates that a charging station for the motor vehicle has been found, additional control signals for controlling the at least one drone are generated in such a way that, during further control of the drone based on the generated additional control signals, the at least one drone monitors the found charging station using its monitoring device and outputs additional monitoring data based on the monitoring, wherein the generated additional control signals are output to further control the at least one drone based on the generated additional control signals, wherein after the output of the additional control signals the additional monitoring data is received and the additional monitoring data is analyzed to determine a further analysis result, which is output.

7. (canceled)

8. The method as claimed in claim 1, wherein, in the case of a plurality of found charging stations, the analysis comprises determining the optimal charging station.

9. (canceled)

10. The method as claimed in claim 1, wherein environment signals are received which represent the environment of the electric motor vehicle, wherein the control signals are generated based on the environment signals and/or wherein the monitoring data is analyzed based on the environment signals.

11. The method as claimed in claim 10, wherein the environment signals comprise environment signals transmitted from an additional motor vehicle which is located in front of the electric motor vehicle with respect to a direction of travel of the electric motor vehicle.

12. The method as claimed in claim 10, wherein the environment signals comprise map signals which represent a digital map of the environment of the electric motor vehicle, indicating a respective position of one or more charging stations.

13. The method as claimed in claim 10, wherein the environment signals comprise environment signals transmitted from a traffic control center and/or from a charging station control center.

14. The method as claimed in claim 1, wherein one, more than one or all method steps are carried out by the electric motor vehicle and/or by the infrastructure and/or by the drone.

15. The method as claimed in claim 1, wherein the method is started only when a current charge state of a drive battery of the electric motor vehicle is less than or equal to a predetermined charge state threshold value, or wherein the method is started proactively independently of the current charge state of the drive battery of the electric motor vehicle.

16. The method as claimed in claim 1, wherein, based on the analysis result, infrastructure assistance data is ascertained for the infrastructure-supported assistance of the electric motor vehicle during an at least partially automatically guided journey to a found charging station and sent to the electric motor vehicle.

17. The method as claimed in claim 1, wherein, based on the analysis result, electric motor vehicle control signals for the at least partially automated control of a transverse and/or longitudinal guidance of the electric motor vehicle are generated and output.

18. The method as claimed in claim 1, wherein the monitoring data and/or the analysis result are sent to a traffic control center and/or a charging station control center.

19. The method as claimed claim 1, wherein the control signals, in particular the additional control signals, are generated in such a way, that, when the at least one drone is controlled based on the generated control signals, the monitoring of the environment comprises a live monitoring of the environment of the electric motor vehicle so that the monitoring data, in particular the additional monitoring data, comprises live monitoring data.

20. The method as claimed in claim 1, wherein one, more than one or all steps of the method are carried out only if one or more safety conditions are met.

21. A device, which is configured to execute all steps of the method as claimed in claim 1.

22. A system for finding a charging station for electric motor vehicles, comprising:
at least one drone, wherein the at least one drone has a monitoring device, and
the device as claimed in claim 21.

23-24. (canceled)
